(19) United States
(12) Patent Application Publication
(10) Pub. No.: US 2006/0019099 A1
(43) Pub. Date: Jan. 26, 2006

(54) Method for making multilayer film, sheet and articles therefrom

(75) Inventors: Hua Wang, Clifton Park, NY (US); Joseph Anthony Suriano, Clifton Park, NY (US); Luca Saggese, Pittsfield, MA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/894,952

(22) Filed: Jul. 20, 2004

(51) Int. Cl. B32B 27/36

(52) U.S. Cl. 428/412

(57) ABSTRACT

A multilayer thermoformable film comprises (A) a top-layer thermoplastic film having an inner surface and an outer surface, where the top layer thermoplastic film has a softening temperature, (B) at least one mask layer thermoplastic film, where the mask layer thermoplastic film has a softening temperature that is within about 30 degrees centigrade of the softening temperature of the top layer film, and (C) at least one tielayer disposed between the inner surface of the top layer film and the mask layer.

### BACKGROUND

This invention relates to a method for making multi-layer thermoformable films and sheets, and articles derived therefrom. More particularly, the invention relates to a method for making thermoformable multi-layer films, sheets, and articles comprising polycarbonate.

In a variety of applications, a thermoplastic film or sheet needs to be thermoformed before it is applied over various substrates. The success of film and sheet technology in these applications generally depends on achieving adequate adhesion between the thermoplastic film and the substrate for the intended application. The substrate may be selected from a diverse set of materials, such as for example, sheet molding compounds, rigid thermosets, reinforced urethane polymers, metals, and thermoplastics.

Thermoformable multilayer sheets in which the top layer film is made of a material comprising a polycarbonate or a polycarbonate copolymer are desirable targets, particularly for automotive applications. For example, multilayer articles comprising a weatherable polycarbonate-polyarylate copolymer film as the cap layer and a plastic substrate, prepared via an in-mold-decoration (IMD) process have demonstrated outstanding properties suitable for applications in automotive exterior panels like fenders and doors, and other outdoor vehicles and devices. Thermoplastics films comprising a polycarbonate or a polycarbonate-polyarylate block copolymer by themselves adhere well only to a very limited range of substrates, such as those made of polycarbonate or a blend of polycarbonate and polybutylene terephthalate. Depending on the substrate choice and adhesion requirements for the application, the use of an adhesive tielayer to achieve optimal performance is often required. For tielayers which become tacky under the thermoforming conditions, the top layer film or sheet tends to adhere to the thermoforming tool, thereby making it difficult to demold the thermoformed part without damaging the film or sheet.

Thus, there is a need for more effective thermoformable multilayer films, particularly those comprising a polycarbonate or a polycarbonate-polyarylate copolymer, which can be used with a diverse set of substrates. Furthermore, there is a need for suitable tie layers and auxiliary layers, such as masking layers, which will enable the molded thermoformed part to be de-molded easily and cleanly after the thermoforming operation, but without damaging the film or the sheet. The latter type of thermoformable films or sheets are especially valuable since they can be shipped to molders who can use them to produce thermoformed articles and injection-molded articles without damaging the top layer of the thermoformed or the molded articles.

### BRIEF SUMMARY OF THE INVENTION

In one embodiment of the present invention, a multilayer thermoformable film comprises (A) a top-layer thermoplastic film having an inner surface and an outer surface, wherein the top layer thermoplastic film has a softening temperature, (B) at least one mask layer thermoplastic film, wherein the mask layer thermoplastic film has a softening temperature that is within about 30 degrees centigrade of the softening temperature of the top layer film, and (C) at least one tielayer disposed between the inner surface of the top layer film and the mask layer.

In a second embodiment of the present invention, a method for making a multilayer thermoformable article comprises (A) laminating an outer surface of at least one tie layer to an inner surface of at least one top layer thermoplastic film, (B) laminating an inner surface of the at least one tie layer to an outer surface of at least one mask layer thermoplastic film, and (C) laminating an inner surface of the at least one mask layer thermoplastic film to an outer surface of a substrate layer; wherein the tielayer is disposed between the inner surface of the at least one top layer thermoplastic film and the outer surface of the at least one mask layer thermoplastic film.

In a third embodiment of the present invention, a method of making a molded article comprises: providing a multilayer thermoformable film, wherein the film comprises (A) a top-layer thermoplastic film having an inner surface and an outer surface, the top layer thermoplastic film having a softening temperature, (B) at least one mask layer thermoplastic film, wherein the mask layer thermoplastic film has a softening temperature that is within about 30 degrees centigrade of the softening temperature of the top layer film, and (C) at least one tielayer disposed between the inner surface of the top layer film and the mask layer; and heating and contacting said multilayer thermoformable film with a thermoforming tool to provide the molded article

In a fourth embodiment of the present invention, a molded three-dimensional article comprises a multilayer thermoformable film, where the multilayer thermoformable film comprises (A) a top-layer thermoplastic film having an inner surface and an outer surface, wherein the top layer thermoplastic film has a softening temperature, (B) at least one mask layer thermoplastic film, where the mask layer thermoplastic film has a softening temperature that is within about 30 degrees centigrade of the softening temperature of the top layer film, and (C) at least one tielayer disposed between the inner surface of the top layer film and the mask layer.

In a fifth embodiment of the present invention, a method of making an in-mold decorated article comprises: (A) laminating an outer surface of at least one tie layer to an inner surface of at least one top layer thermoplastic film, (B) laminating an inner surface of the at least one tie layer to an outer surface of at least one mask layer thermoplastic film, (C) laminating an inner surface of the at least one mask layer thermoplastic film to an outer surface of a substrate to form a multilayer thermoformable film, (D) heating and contacting with a thermoforming tool, the multilayer thermoformable film to produce a molded film, and (E) injection molding or compression molding a substrate layer with the molded film to produce a finished article.

### DETAILED DESCRIPTION OF THE INVENTION

The present invention may be understood more readily by reference to the following detailed description of preferred embodiments of the invention and the examples included therein. In the following specification and the claims which follow, reference will be made to a number of terms which shall be defined to have the following meanings:

As disclosed herein, the terms “mold”, and “tool” are used interchangeably. The singular forms “a”, “an” and “the” include plural referents unless the context clearly dictates otherwise. The term “hydrocarbon” as used herein is intended to designate aromatic groups, and aliphatic groups, such as alkyl groups. The term “alkyl” as used herein is intended to designate straight chain alkyls, branched alkyls, aralkyls, cycloalkyls, and bicycloalkyl groups. Suitable illustrative non-limiting examples of aromatic groups include, for example, substituted and unsubstituted phenyl groups. The straight chain and branched alkyl groups include as illustrative non-limiting examples, methyl, ethyl, n-propyl, isopropyl, n-butyl, sec-butyl, tertiary-butyl, pentyl, neopentyl, hexyl, heptyl, octyl, nonyl, decyl, undecyl and dodecyl. In various embodiments, cycloalkyl groups represented are those containing about 3 to about 12 ring carbon atoms. Some illustrative non-limiting examples of these cycloalkyl groups include cyclobutyl, cyclopentyl, cyclohexyl, methylcyclohexyl, and cycloheptyl. In various other embodiments, aralkyl groups are those containing about 7 to 14 carbon atoms; these include, but are not intended to be limited to, benzyl, phenylbutyl, phenylpropyl, and phenylethyl. In various other embodiments, aromatic groups are intended to designate monocyclic or polycyclic moieties containing about 6 to about 12 ring carbon atoms. These aryl groups may also contain one or more halogen atoms or alkyl groups substituted on the ring carbons. Some illustrative non-limiting examples of these aromatic groups include phenyl, halophenyl, biphenyl, and naphthyl.

The present invention includes thermoformable multilayer sheets or films comprising a polycarbonate or a polycarbonate-polyarylate copolymer, methods for producing such films or sheets, and methods for producing molded articles using these films or sheets.

The methods employ a masking layer (Mask layer) that has weak adhesion to the thermoforming tool during thermoforming operations, thereby preventing direct contact of the tacky tielayer with the mold, while ensuring clean and easy release of formed films and sheets from the thermoforming mold. Another aspect of the invention includes multilayer molded articles obtained using these multilayer thermoformable sheets or films.

In one aspect, the method of the present invention overcomes the thermoforming issues (adhesion to mold, poor mold release, etc.) encountered when multilayer films comprising a tie layer are molded by employing an engineering thermoplastic “mask layer” such that the mask layer adheres strongly to the tielayer while releasing cleanly and easily from the mold during the thermoforming process. The mask layer effectively prevents direct contact of the tacky tielayer with mold surfaces during the thermoforming operation. A substrate compatible with the mask layer may be subsequently injection molded with the thermoformed multilayer film to make the finished article. Hence, in certain aspects of the invention, the mask layer film becomes an integral layer of the finished thermoformed article. For optimum performance, the mask layer should have the following properties: (1) it should adhere strongly with the tielayer; (2) it should be stretchable without blistering during the thermoforming steps; (3) it should be easy releasable from the mold/substrate/tool after the thermoforming step, and (4) it should be compatible and strongly adherent with the substrate layer. In one embodiment, a strongly or a permanently adherent mask layer is one which exhibits a peel strength with a tielayer of greater than 1400 Newtons per meter, as measured using the ASTM D1876 test method.

In a second aspect of the method of the present invention, a removable mask layer or a mask film is laminated to the tielayer film portion of a multilayer film. The mask layer is designed to prevent direct contact of the tacky tielayer with the mold during thermoforming. After the thermoforming step, the mask layer can be released cleanly and easily from the mold to provide a molded multilayer film (a thermoformed multilayer film). The mask layer can then be removed from the molded multilayer film by peeling it away from the tielayer to expose the tielayer and facilitate the subsequent adhesion of the tielayer with a substrate layer. For optimum performance, the removable mask layer (film) should have the following properties: (1) it should be weakly adherent with the tielayer; (2) it should be stretchable without blistering during the thermoforming process; (3) it should be easily releasable from the mold/tool during thermoforming; and (4) it should be easily removable from the adhesive tielayer after the thermoforming step. Such multilayer thermoformable sheets or films can be advantageously shipped to thermoformers or molders who can use them to produce thermoformed or molded parts, and subsequently remove the peelable, weakly adherent mask layer film to produce finished parts. The peelable masking film typically has an adhesion strength with the tielayer of from about 175 to about 1400 Newtons per meter as measured using the ASTM D1876 test method. In one embodiment, the peelable masking film has an adhesion strength with the tielayer of from about 525 to about 1400 Newtons per meter as measured using the ASTM D1876 test method. When thermoformable films or sheets are used for pre-forming to provide a molded film or sheet (the “preform”) followed by injection molding the perform together with a substrate layer to produce an article comprising the molded film or sheet attached to a substrate layer, it is desirable that the mask layer film stay adhered to the preform until it is peeled off before inserting the preform into the mold during the injection molding process.

The top layer thermoplastic film can be any polymer that comprises carbonate structural units. Exemplary thermoplastic films which may serve as the top layer typically comprise at least one polycarbonate or a polyestercarbonate. In some embodiments, the top layer thermoplastic film may be comprised of a plurality of thermoplastic films each of which may comprise different types of polycarbonate and/or polyarylate polymers. Thus in one embodiment, the multilayer thermoformable film comprises a top layer film which comprises a first thermoplastic film layer and a second thermoplastic film layer. The first thermoplastic film layer may comprise a polyarylate comprising structural units of formula (I) 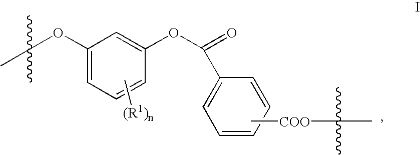
wherein R¹ is independently at each occurrence a C₁-C₁₂ alkyl group, or a halogen atom, and n is 0 to 3; and structural units of formula (II) 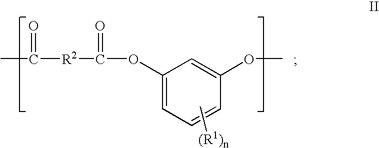
wherein R¹ is independently at each occurrence a C₁-C₁₂ alkyl group, or a halogen atom, R² is a C₁-C₅₀ divalent hydrocarbon radical, and n is 0 to 3; and the second thermoplastic film layer comprises a polycarbonate

Suitable examples of R² groups include groups derived from aliphatic dicarboxylic acids, such as succinic acid, adipic acid, or cyclohexane-1,4-dicarboxylic acid; or from aromatic dicarboxylic acids, such as 1,8-naphthalene dicarboxylic acid.

As noted, formula (I) comprises structural subunits derived from a resorcinol or substituted resorcinol moiety in which any R¹ group may be halogen or C₁-C₁₂ alkyl; for example, methyl, ethyl, propyl, butyl, and dodecyl groups. In one embodiment, at least one of the R¹ groups is methyl. In some embodiments, structural units represented by formula I comprise unsubstituted resorcinol moieties (n is zero), although resorcinol moieties in which n is 1 to 3 are also suitable. The resorcinol moieties are most often bound to isophthalate and/or terephthalate moieties as depicted by the diacid structural subunit of formula I.

Structural units having formula (II) comprise resorcinol or substituted resorcinol moieties and are present in combination with a diacid moiety comprising the R² group, where R² is a C₁-C₅₀ divalent hydrocarbon radical. Divalent hydrocarbon radicals include linear and branched alkylene, arylene, aralkylene, alkarylarylene, and cycloalkylene radicals. In some embodiments, R² comprises a C₄-C₁₂ straight chain divalent aliphatic radical, for example a (CH₂)₁₂ radical (dodecamethylene radical).

The arylate polymers comprising structural units having formulae (I) and (II) can be prepared using standard synthetic methods, such as interfacial polymerization methods, polymerization in homogeneous solution, melt polycondensation, or solid state polymerization methods, all of which are known in the art. For example, typical interfacial polymerization methods are described in commonly owned U.S. Pat. Nos. 5,916,997 and 6,607,814 both of which references are incorporated herein by reference in their entirety. Other arylate polymers suitable for use in the various aspects of the present invention include those arylate polymers disclosed in commonly owned U.S. Pat. No. 6,143,839 which reference is incorporated herein in its entirety. Preferred arylate polymers include the LEXAN® SLX series of polyarylates, exemplified by optically clear resins, such as LEXAN® SLX 2431; and opaque resins, such as LEXAN® SLX EXRL0124 and EXRL0125 resins. Such arylate polymers are available from GE Advanced Materials, Mt. Vernon, Ind.

In one embodiment, the top layer film itself comprises a layer of a polyarylate film laminated with a layer of a polycarbonate film. Such two-layer laminates can be prepared by known methods, such as for example, co-extruding a polyarylate and a polycarbonate through a suitable die. The second film layer may comprise any polycarbonate. Suitable polycarbonates that can be used as a “single layer top layer” thermoplastic film, or as a thermoplastic film layer in a “multilayer top layer” thermoplastic film (a plurality of films make up the top layer film), are those polycarbonates comprising structural units derived from at least one aromatic dihydroxy compound of formula (III): 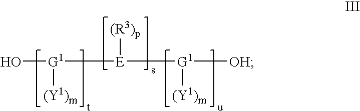
wherein each G¹ is independently an aromatic group; E is selected from the group consisting of an alkylene group, an alkylidene group, a cycloaliphatic group, a sulfur-containing linkage, a phosphorus-containing linkage, an ether linkage, a carbonyl group, a tertiary nitrogen atom, and a silicon-containing linkage; R³ is independently at each occurrence a hydrogen atom, a halogen atom, or a monovalent hydrocarbon group; Y¹ is independently at each occurrence a monovalent hydrocarbon group, an alkenyl group, an allyl group, a halogen atom, an alkoxy group, or a nitro group; each m is independently a number from zero through the number of positions on each respective G¹ available for substitution; p is a whole number from zero through the number of positions on E available for substitution; t is a number greater than or equal to one; s is either zero or one; and u is a whole number including zero.

The mask layer thermoplastic film comprises at least one thermoplastic polymer selected from the group consisting of a polycarbonate, a poly(arylene ether), a poly(alkenylaromatic) polymer, a polyolefin, a vinyl polymer, an acrylic polymer, a polyacrylonitrile, a polystyrene, a polyester, an acrylonitrile-styrene-acrylate copolymer, an acrylonitrile-butadiene-styrene copolymer, a polyester, a polyamide, a polysulfone, a polyimide, a polyetherimide, a polyphenylene ether, a polyphenylene sulfide, a polyether ketone, a polyether ether ketone, a polyethersulfone, a polybutadiene, a polyacetal, an ethylene-vinyl acetate copolymer, a polyvinyl acetate, a liquid crystal polymer, an ethylene-tetrafluoroethylene copolymer, a polyvinyl fluoride, a polyvinylidene fluoride, a polyvinylidene chloride, a polytetrafluoroethylene, a polycarbonate-polyorganosiloxane block copolymer, a copolymer comprising aromatic ester estercarbonate and carbonate repeat units, and mixtures and blends comprising at least one of the foregoing polymers. In a particular embodiment, the mask layer comprises at least one thermoplastic polymer selected from the group consisting of a polycarbonate, a polyphenylene oxide-polystyrene blend, a polycarbonate-polyphenylene oxide blend, an ABS resin, an ASA resin, a polycarbonate-ABS blend, a polycarbonate-ASA blend, a polycarbonate-polybutylene terephthalate blend, and a polyphenylene oxide-nylon blend. In one embodiment, the mask layer thermoplastic film comprises a thermoplastic polymer having a softening temperature or vicat softening point, as measured using ASTM D1525 method of from about 100° C. to about 160° C. The masking layer may further comprise a mold release agent coated on at least one surface of the masking layer. The mold release agent facilitates release of the multilayer film from the thermoform mold or release of the mask layer from the tie layer. Exemplary mold release agents include those that comprise a silicone material as are known in the art.

The tie layer thermoplastic film comprises at least one thermoplastic polymer selected from the group consisting of a polyurethane, a copolymer of a polyurethane with a polyester, a copolymer of a polyurethane with a polyamide, and a copolymer of a polyurethane with a styrenic block copolymer. The tie layer may comprise one or more thermoplastic polymers having a ninety-degree peel strength with respect to the at least one mask layer thermoplastic film of greater than 1400 Newtons in one embodiment, and greater than 700 Newtons per meter in another embodiment, as measured using the ASTM D1876 method.

Suitable substrates for use in the present invention comprise at least one of a thermoplastic polymer, a thermoset polymer, a ceramic, a glass, a cellulosic material, or a metal. Representative metal substrates include those comprising brass, aluminum, magnesium, chrome, iron, steel, copper, and other metals or alloys or articles containing them, which may require protection from ultraviolet light or other weather phenomena. Typically, when a glass layer is present in an embodiment of the present invention, it plays the role of a substrate layer. However, multilayer articles comprising a polymer film layer interposed between a glass layer and a substrate layer, which is not glass are also contemplated. At least one adhesive tielayer may be beneficially employed between a glass substrate layer and the top layer film. In some embodiments, the tielayer may be optically transparent and have a transmission of greater than about 60% and a haze value of less than about 3% with no objectionable color. Suitable cellulosic materials which may serve as the substrate in various embodiments of the present invention include wood, paper, cardboard, paper, Kraft paper, cellulose nitrate, cellulose acetate butyrate, and the like. Blends of at least one cellulosic material with at least one thermoset polymer (particularly an adhesive thermoset polymer), or at least one thermoplastic polymer (particularly a recycled thermoplastic polymer, such as polyethylene terephthalate or polycarbonate), can also be used.

Thermoset polymers include those derived from epoxies, cyanate esters, unsaturated polyesters, diallyl phthalate, acrylics, alkyds, phenol-formaldehyde condensates, including novolacs and resols), melamine-formaldehyde condensates, urea-formaldehyde condensates, bismaleimides, PMR (polymerization of monomeric reactants) type resins, benzocyclobutanes, hydroxymethylfurans, isocyanates, and mixtures of the foregoing. In some particular embodiments a substrate of the invention comprises at least one filled substrate layer selected from the group consisting of sheet-molding compounds (SMC), vinyl ester SMC, bulk molding compounds (BMC), thick molding compounds (TMC), structural reaction injected molded compounds (SRIM), and an acrylic ester-derived thermoset resins comprising a polyphenylene ether. Sheet molding compounds (SMC) are moldable composite materials often comprising an unsaturated liquid polyester resin, a low profile thermoplastic resin, an inert filler, a curing aid, and short lengths of glass fiber reinforcing materials. Among illustrative fiberglass reinforced thermoset substrates suitable for use in the invention are those provided by Ashland Specialty Chemical, Dublin, Ohio, GenCorp, Marion, Ind., Rockwell International Corporation, Centralia, Ill., Budd Company, Madison Heights, Mich., and Eagle Picher Plastics, and Grabill Industries. The SRIM substrates suitable for the use in various embodiments of the present invention include those provided by Bayer, Pittsburgh, Pa. Exemplary vinyl ester SMC substrates include those manufactured by Dow Chemical, Midland, Mich.

In a particular embodiment, a suitable fiberglass reinforced thermoset substrate is a long fiber injection polyurethane (LFI-PU) foam. LFI-PU RIM (Reaction Injection Molding) may be used for the manufacture of, for example, horizontal body panels for automotive applications. The advantages of LFI-PU foam include improved stiffness, high strength to weight ratio, and low coefficient of thermal expansion. During the LFI-PU RIM process, the two liquid components, isocyanate and polyol, are fed through supply lines to metering units that precisely meter both components, at high pressure, to a mix-head device. The long fibers generally have a length of more than 5 millimeters in one embodiment, more than 10 millimeters in another embodiment, and from about 10 millimeters to about 10 centimeters in yet another embodiment. The long fibers used may comprise glass fibers, natural fibers, such as those of flax, jute or sisal; or synthetic fibers, such as polyamide fibers, polyester fibers, carbon fibers or polyurethane fibers; and are generally used in an amount of from about 0.1 to about 90 weight percent, based on the overall weight of the LFI-PU foam. The long fibers, example glass fibers are cut from a roving (a loosely associated bundle of untwisted filaments or strands) and deposited in the mold drenched with the polyurethane component using a suitable device, such as for example, the Krauss-Maffei process head. Inside the mold, the liquid undergoes an exothermic chemical reaction and forms the long glass fiber-reinforced polyurethane. Reinforcement of the polyurethane foam can also be accomplished by introducing the long fibers in the form of mats.

The substrate layer may additionally comprise art-recognized additives, non-limiting examples of which include colorants, pigments, dyes, impact modifiers, stabilizers, such as for example, color stabilizers, thermal stabilizers, UV screeners, UV absorbers, flame retardants, flow aids, ester interchange inhibitors, and mold release agents.

Applicable thermoplastic polymers which may be used as the substrate layer include addition polymers and condensation polymers. In an embodiment, the thermoplastic polymer is at least one polymer selected from the group consisting of a polycarbonate, an ABS resin, an ASA resin, a polycarbonate-ABS blend, a polycarbonate-ASA blend, a polyphenylene oxide, a polycarbonate-polyphenylene oxide blend, a polycarbonate-polybutylene terephthalate blend, a polyolefin, a polypropylene, and a rubbery impact-modified polyolefin. Other examples of thermoplastic polymers include polyphenylene sulfides, polyimides, polyamideimides, polyetherimides, polyetherketones, polyaryletherketones, polyamides, liquid crystalline polyesters, polyetheresters, polyetherimides, polyestercarbonates, and polyesteramides. The polycarbonate and ABS, respectively, are as before described. LEXAN® polycarbonate resin and CYCOLAC® resin are available from GE Advanced Materials, a component of the General Electric Company. ABS/polycarbonate resin is also available from GE Advance Materials under the trade name CYCOLOY® resin. Suitable ABS/polycarbonate blends contain about 15 to about 85-weight percent polycarbonate and about 15 to about 85 weight percent ABS resin. Other suitable examples of thermoplastic polymers include the series of VALOX® resins, the XENOY® series of materials, which are blends of polycarbonate and polyester resins; and the NORYL® series of materials, which are blends of polyphenylene ether and polystyrene resins; all of which are available commercially from GE Advanced Materials.

In some embodiments of the present invention, the top layer comprises a coating layer comprising a block polyestercarbonate copolymer and a second layer comprising a polymer comprising carbonate structural units. The two layers comprising the top layer may be formed into a copolyestercarbonate/carbonate-comprising polymer pre-assembly comprising at least two layers. Such a pre-assembly can be made by known methods, such as by coextrusion of films or sheets of the two materials. For example, the coextrusion can be carried out using a coextrusion die, which is capable of receiving two or more molten polymer feeds and depositing layers of such molten polymer feeds to form a multilayer film structure. This technique allows the formation of multilayer film structures with fewer processing steps when compared to other hot assembly methods, which involve separate coating and lamination steps. Further, coextrusion also allows the operator to better control processing variables, such as temperature, pressure, line speed, and dwell time in forming secure bonds with selected thermoplastic substrates. In other embodiments such a pre-assembly can be made by lamination, or solvent or melt coating. In a particular embodiment application of the coating layer to the second layer is performed in a melt process. Suitable methods for application include fabrication of a separate sheet of the coating layer followed by application to the second layer, as well as simultaneous production of both layers. Thus, there may be employed such illustrative methods as molding, compression molding, thermoforming, co-injection molding, coextrusion, overmolding, multi-shot injection molding, sheet molding and placement of a film of the coating layer material on the surface of the second layer followed by adhesion of the two layers, typically in an injection molding apparatus; e.g., in-mold decoration. These operations may be conducted under art-recognized conditions.

The multilayer thermoformable film structures described hereinabove can be formed into shaped parts or articles by thermoforming methods well known in the art, such as for example, drape forming, vacuum forming, free forming, pneumatic performing, plug assist forming, pressure forming, diaphragm forming, twin-sheet forming, contact forming, mechanical forming, and combinations thereof. Heating of the film or sheet to the proper forming temperature can be achieved by conductive, convective, or radiative heating. For handling fast-setting films, the thermoforming equipment should be equipped to pull a vacuum on the parts as the film heats and forms. New heating technology, such as halogen “flash” heaters and material-control systems such as zero gravity control systems are particularly useful for obtaining “Class A” thermoformed surfaces and thermoformed surfaces which are essentially equivalent to “Class A” thermoformed surfaces. Thermoforming production tools for LEXAN SLX films are preferably made of aluminum. In an embodiment, the temperature of the tool should preferably be at least 110° C.

One variant of the thermoforming technique, also sometimes called “form-in-place molding”, is carried out by placing a flat film structure into an injection mold and injecting a molten thermoplastic polymer behind the film, thereby enabling the film structure to take the shape of the injection mold. In another adaptation of the thermoforming technique, the multilayer film structures can be thermoformed into shells and used in “insert injection molding” processes, wherein a molten plastic resin is introduced behind the shell. When the multilayer film films are adequately thick, such as for example, 50 mils (about 1.7 millimeters) or greater, the multilayer films can be thermoformed directly into parts without the need for further lamination to a supporting thermoplastic substrate or without injection molding. The techniques described above are particularly useful as a dry paint for surfaces of articles, such as parts for automobiles, recreational vehicles, marine vehicles, sports and farm equipment, and the like.

In another embodiment of the invention, the multilayer thermoformable films are very useful for producing thermoformed articles using the so-called “in mold decoration” (hereinafter sometimes referred to as “IMD”) process. In one embodiment, the IMD process involves film or sheet extrusion, thermoforming, back-molding and edge-trimming of the back-molded part. Thermoformed parts play two roles in in-mold decorating of plastic parts. For injection molding, IMD begins by thermoforming a thin film into decorative shells that are placed in the injection mold cavity and then back-molded to a compatible substrate. A second way to exploit decorative films is via the so called “Thick Sheet Forming” technique, or TSF. TSF involves laminating or coextruding a decorative film or material onto a heavy-gauge (0.06 to 0.3 inch thick) sheet substrate for subsequent thermoforming directly into finished parts. TSF is also suitable for fabricating large, flat panels having relatively low volumes. IMD is well known for attaching graphics, such as logos and model names, directly onto complex 3-dimensional parts without secondary operations. A film in either roll or sheet form undergoes sequenced drying, thermoforming, and trimming. Next a back molding step puts the film into the injection-molding tool before the substrate resin is injected into the mold.

In the thermoforming step, the processing melt temperatures of the thermoplastic top layer film, the tie layer film, and where appropriate, the substrate film plays a key role. A low melt temperature, for example, can limit shape forming capabilities and, most importantly, may reduce adhesion. Too high a melt temperature, on the other hand, may degrade the physical properties of the thermoformed film and may result in film color washout. Designers can make a preliminary forming analysis for IMED parts by reducing part wall thickness by the thickness of the film. Heat loss may occur rapidly during the forming of the thin IMD films and as a result thermoforming equipment must be optimized to insure appropriate heat management. In processing LEXAN SLX films, it is preferred that the thermoforming machine employed be able to transfer films from the heating zone to the forming station in less than 3 seconds.

After the thermoforming step, a trimming operation is typically carried out to remove excess material. Several trimming technologies are known in the art. The distinguishing capabilities of a given trimming technique are linked to part size, film thickness, part geometry, and production volumes. Typical equipment for 2-dimensional trimming includes matched metal, hot and cold knife, and die cutting devices. For three-dimensional geometries, a five or six-axis robot-wielding laser, an ultrasonic knife, or CNC (Computer numerical control) router technology may be used. The laser-based system is generally preferred for extremely complicated 2-dimensional and 3-dimensional geometries.

The thermoformed film is next fitted into an injection-molding tool. The success of an IMD part often hinges on the fit of the thermoformed film in the injection-molding tool. But other key considerations include a proper gating system, the right wall thickness, the proper tonnage, registration method, and automation plan. Gating accounts for part filling capability, film and color washout, and often part performance. Large parts demand careful use of multiple drops to avoid knit line read-through to the show surface and to keep the part from deforming during thermal cycling. Proper gating design helps in preventing the color layer wash out, and can often aid in the registration of the film. Walls with a uniform thickness in the tool will help produce a uniform aesthetic surface. A sudden change in substrate thickness translates into a defect on the part's first surface. The film registration must be robust to repeatedly deliver good IMD parts. Typical registration methods include part geometry, mechanical aids, electrostatic charges, and vacuum. The molding techniques are particularly useful for making molded three-dimensional articles comprising the thermoformable multilayer films or sheets described previously.

The multilayer thermoformable films disclosed herein are valuable for producing a variety of articles having a glossy (paint-like), class A finish. Examples of such articles include those which will be exposed to weather phenomena, such as ultraviolet light, whether natural or artificial, during their lifetimes, and most particularly articles intended for outdoor use. LEXAN® SLX films are excellent candidates for producing such articles since they exhibit excellent toughness, a performance characteristic frequently required in such applications. Further LEXAN® SLX films have an outstanding aesthetic appearance, and demonstrate resistance to scratching and attack by chemicals. Moreover, traditional indoor applications including consumer electronics and cell phones are candidates as well because IMD easily promotes product differentiation. Simple changes in film color or graphics, for example, can provide an easy means of reintroducing an existing part as a new model. In addition, IMD using the LEXAN SLX film may also allow product designers to use re-grind materials or less-costly commodity-based resins as substrates without losing surface quality or performance. Suitable articles are exemplified by parts comprising aircraft, automotive, truck, military vehicle, scooter, and motorcycle exterior and interior components, including panels, quarter panels, rocker panels, trim, fenders, doors, deck lids, trunk lids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps housings, tail lamp bezels, license plate enclosures, roof racks, and running boards; enclosures, housings, panels, and parts for outdoor vehicles and devices; enclosures for electrical and telecommunication devices; outdoor furniture, aircraft components; boats and marine equipment, including trim, enclosures, and housings; outboard motor housings, depth finder housings, personal water-craft, jet skis, pools, spas, hot-tubs, steps, step coverings, building and construction applications, such as glazing, roofs, windows, floors, decorative window furnishings or treatments; treated glass covers for pictures, paintings, posters, and like display items; optical lenses; ophthalmic lenses; corrective ophthalmic lenses; implantable ophthalmic lenses; wall panels, and doors; counter tops; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; phone bezels; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; interior and exterior architectural paneling, and like applications.

### EXAMPLES

The following examples are set forth to provide those of ordinary skill in the art with a detailed description of how the methods claimed herein are evaluated, and are not intended to limit the scope of what the inventors regard as their invention.

Ninety-degree peel force was measured in accordance with the procedure set forth in the ASTM D1876 test method. The peel strength (P) was then calculated by dividing the peeling load (measured in Newtons) by the width of the specimen (measured in meters). Vicat softening temperature was determined in accordance with the procedure set forth in the ASTM D1525 method.

Evaluations were carried out using LEXAN® SLX films (a two-layer laminate comprising a polyarylate film and a polycarbonate film) obtained from GE Advanced Materials, as the first layer. Tielayer maskings (the mask layer) included NORYL® PPX 7112, NORYL® PPX 7135, and NORYL® PKN 4736 resins obtained from GE Advanced Materials, UAR-9169 thermoplastic polyurethane (TPU) resin obtained from Adhesive Films Inc, Polyethylene films GHX 529 and GHX 411 obtained from Bischof and Klein, and three 10 mil thick polypropylene films, namely white PROPAQUE®, black soft PROPLAST®, and white Z00447 obtained from American Profol, Inc.

The three NORYL® resins described above were extruded into 3-mil thick 56 inch wide films using a 3.5 inch diameter extruder equipped with a 66 inch wide film die. These maskings were rolled up separately and used on a need basis, throughout the experimentation. The LEXAN® SLX film was extrusion coated with a 3 mil thick tie layer of UAR-9169 resin using the same extruder/film die set-up utilized to make the NORYL maskings. The TPU tielayer coated LEXAN® SLX film is sometimes referred to hereinafter as “3-layer LEXAN® SLX film”

### Examples 1-3

Three extruded NORYL® films (NORYL PPX 7112, NORYL® PPX 7135, or NORYL® PKN 4736) were each laminated separately over the tielayer side of the 3-layer Lexan® SLX film. These multilayer films (with a NORYL® back layer) were heated to about 350° F. and thermoformed. Thermoforming was carried out on a shuttle thermoformer (Model Name: COMET, Serial # 1051) using an aluminum plaque tool measuring 6 inches×8 inches with a 0.5 inch height. The tool was heated to approximately 120° C. Utilizing an initial sheet size of 14 inch×14 inch, the material was heated using top and bottom heaters for approximately 35-40 seconds. The application of vacuum and cooling steps were carried out over about 15 seconds, and air pressure was subsequently applied for 5 seconds to aid in releasing the part. The formed part was released cleanly from the tool (without any residual film left on the surface of the tool) for all 3 cases. These NORYL® films were found to adhere very strongly with the tielayer.

The after-thermoformed films comprising the NORYL back layer (mask layer) as an integral part of the film can be further molded with a compatible substrate to make finished articles. Such a substrate includes LFI-PU, NORYL®, NORYL® PPX, and polypropylene.

### Example 4

One side of the 3-mil thick NORYL® PKN 4736 film was coated with a silicone release coating (4L0-1). The coated NORYL® PKN 4736 film was laminated as the tielayer masking film to the 3-layer LEXAN® SLX film (with the silicone release coated side contacting TPU tielayer). The multilayer film was subsequently thermoformed under the same conditions as in Examples 1-3. The silicone coated NORYL® film was found to have an appropriate degree of adhesion with the tielayer adequate for handling. It stretched with LEXAN® SLX film without blistering during thermoforming. The NORYL® film was also found to release easily and cleanly from the mold during thermoforming (with no residue left on the surface of the tool). After thermoforming, the NORYL® masking film was easily removed (peeled off) from the tielayer as a result of the presence of the silicone release coating. After removal of the masking film, the thermoformed LEXAN® SLX film can be further molded with a compatible substrate, such as NORYL®, NORYL® PPX, or LFI-PU, to make finished articles.

### Comparative Example 1

A 3-layer LEXAN® SLX film was thermoformed under the same conditions as in Examples 1-3. The TPU tielayer became tacky and adhered strongly to the mold during the thermoforming operation. The formed film was impossible to de-mold cleanly after thermoforming, resulting in damaged film and great operational difficulties, such as extra tool cleaning for each forming cycle, long cycle time, and low productivity.

### Comparative Examples 2-6

The 5 polyethylene and polypropylene films were each laminated to the 3-layer LEXAN® SLX films. The multilayer films (with a polyethylene or polypropylene tielayer masking film) were thermoformed under the same conditions as in Example 1-3. The polyethylene and polypropylene masking films were found to adhere to the mold, making the thermoformed films difficult to de-mold. After the formed films were forced to de-mold from the tool, a significant quantity of the residual masking film was left on the surface of the tool for all 5 cases.

### Comparative Examples 7-8

One side of a polyethylene GHX 411 and a polypropylene Z00447 masking films were coated with a silicone release coating. The masking films were each laminated as tielayer masking layers over separate 3-layer LEXAN® SLX film films (with silicone release coated side facing outside so it contacts the tool during subsequent thermoforming step). The multilayer film (with polyethylene or polypropylene tielayer masking film) was thermoformed under the same conditions as in Examples 1-3. The formed parts were found to be difficult to de-mold. After the formed parts were forced to de-mold, a significant quantity of the residual masking film was left on the surface of the tool for all cases.

The invention has been described in detail with particular reference to preferred embodiments thereof, but it will be understood by those skilled in the art that variations and modifications can be effected within the spirit and scope of the invention.

What is claimed is:

1. A multilayer thermoformable film comprising (A) a top-layer thermoplastic film having an inner surface and an outer surface, said top layer thermoplastic film having a softening temperature, (B) at least one mask layer thermoplastic film, said mask layer thermoplastic film having a softening temperature within about 30 degrees centigrade of the softening temperature of the top layer film, and (C) at least one tielayer disposed between said inner surface of the top layer film and said mask layer.

2. The multilayer thermoformable film of claim 1, wherein said top layer thermoplastic film comprises a polymer comprising carbonate structural units.

3. The multilayer thermoformable film of claim 2, wherein said polymer comprising carbonate structural units is selected from the group consisting of a polycarbonate and a polyestercarbonate.

4. The multilayer thermoformable film of claim 1, wherein said top layer thermoplastic film comprises a first thermoplastic film layer and a second thermoplastic film layer, wherein said first thermoplastic film layer comprises structural units of formula (I): 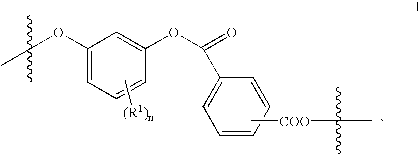
wherein R¹ is independently at each occurrence a C₁-C₁₂ alkyl group, or a halogen atom, and n is 0 to 3; and
structural units of formula (II): 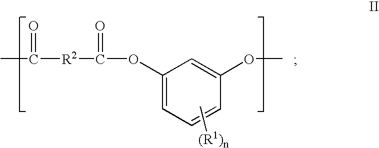
wherein R¹ is independently at each occurrence a C₁-C₁₂ alkyl group, or a halogen atom, R² is a C₁-C₅₀ divalent hydrocarbon radical, and n is 0 to 3; and wherein said second film layer comprises a polycarbonate.

5. The multilayer thermoformable film of claim 3, wherein said polycarbonate comprises structural units derived from at least one aromatic dihydroxy compound of formula (III): 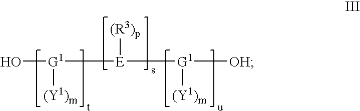
wherein each G¹ is independently an aromatic group; E is selected from the group consisting of an alkylene group, an alkylidene group, a cycloaliphatic group, a sulfur-containing linkage, a phosphorus-containing linkage, an ether linkage, a carbonyl group, a tertiary nitrogen atom, and a silicon-containing linkage; R³ is independently at each occurrence a hydrogen atom, a halogen atom, or a monovalent hydrocarbon group; Y¹ is independently at each occurrence a monovalent hydrocarbon group, an alkenyl group, an allyl group, a halogen atom, an alkoxy group, or a nitro group; each m is independently a number from zero through the number of positions on each respective G¹ available for substitution; p is a whole number from zero through the number of positions on E available for substitution; t is a number greater than or equal to one; s is either zero or one; and u is a whole number including zero.

6. The multilayer thermoformable film of claim 4, wherein said second thermoplastic film layer comprises a polycarbonate comprising structural units derived from at least one aromatic dihydroxy compound of formula (III): 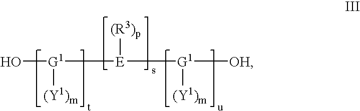
wherein each G¹ is independently an aromatic group; E is selected from the group consisting of an alkylene group, an alkylidene group, a cycloaliphatic group, a sulfur-containing linkage, a phosphorus-containing linkage, an ether linkage, a carbonyl group, a tertiary nitrogen atom, and a silicon-containing linkage; R³ is independently at each occurrence a hydrogen atom, a halogen atom, or a monovalent hydrocarbon group; Y¹ is independently at each occurrence a monovalent hydrocarbon group, an alkenyl group, an allyl group, a halogen atom, an alkoxy group, or a nitro group; each m is independently a number from zero through the number of positions on each respective G¹ available for substitution; p is a whole number from zero through the number of positions on E available for substitution; t is a number greater than or equal to one; s is either zero or one; and u is a whole number including zero.

7. The multilayer thermoformable film of claim 1, wherein said at least one mask layer thermoplastic film comprises at least one thermoplastic polymer selected from the group consisting of a polycarbonate, a poly(arylene ether), a poly(alkenylaromatic) polymer, a polyolefin, a vinyl polymer, an acrylic polymer, a polyacrylonitrile, a polystyrene, a polyester, an acrylonitrile-styrene-acrylate copolymer, an acrylonitrile-butadiene-styrene copolymer, a polyester, a polyamide, a polysulfone, a polyimide, a polyetherimide, a polyphenylene ether, a polyphenylene sulfide, a polyether ketone, a polyether ether ketone, a polyethersulfone, a polybutadiene, a polyacetal, an ethylene-vinyl acetate copolymer, a polyvinyl acetate, a liquid crystal polymer, an ethylene-tetrafluoroethylene copolymer, a polyvinyl fluoride, a polyvinylidene fluoride, a polyvinylidene chloride, a polytetrafluoroethylene, a polycarbonate-polyorganosiloxane block copolymer, a copolymer comprising aromatic ester estercarbonate and carbonate repeat units, and mixtures and blends comprising at least one of the foregoing polymers.

8. The multilayer thermoformable film of claim 1, wherein said at least one mask layer comprises at least one thermoplastic polymer selected from the group consisting of a polycarbonate, a polyphenylene oxide-polystyrene blend, a polycarbonate-polyphenylene oxide blend, an ABS resin, an ASA resin, a polycarbonate-ABS blend, a polycarbonate-ASA blend, a polycarbonate-polybutylene terephthalate blend, and a polyphenylene oxide-nylon blend.

9. The multilayer thermoformable film of claim 1, wherein said at least one mask layer thermoplastic film comprises a thermoplastic polymer having a vicat softening point, as measured using ASTM D1525 method of from about 100° C. to about 160° C.

10. The multilayer thermoformable film of claim 1, wherein said at least one tie layer comprises at least one thermoplastic polymer selected from the group consisting of a polyurethane, a copolymer of a polyurethane with a polyester, a copolymer of a polyurethane with a polyamide, and a copolymer of a polyurethane with a styrenic block copolymer.

11. The multilayer thermoformable film of claim 1, wherein said at least one tie layer comprises at least one thermoplastic polymer having a ninety degree peel strength with respect to said at least one mask layer thermoplastic film of greater than or equal to about 700 Newtons per meter, as measured using the ASTM D1876 test method.

12. The multilayer thermoformable film of claim 1, wherein said at least one tie layer further comprises a mold release agent.

13. The multilayer thermoformable film of claim 12, wherein said mold release agent comprises a silicone-containing compound.

14. A method for making a multilayer thermoformable article, said method comprising:
(a) laminating an outer surface of at least one tie layer to an inner surface of at least one top layer thermoplastic film,
(b) laminating an inner surface of said at least one tie layer to an outer surface of at least one mask layer thermoplastic film, and
(c) laminating an inner surface of said at least one mask layer thermoplastic film to an outer surface of a substrate layer;
wherein said multilayer thermoformable film comprises said at least one tielayer disposed between said inner surface of said at least one top layer thermoplastic film and said at least one mask layer thermoplastic film.

15. The method of claim 14, wherein said substrate layer comprises at least one of a thermoplastic polymer, a thermoset polymer, or a metal.

16. The method of claim 14, wherein said substrate layer comprises at least one thermoplastic polymer selected from the group consisting of a polycarbonate, an ABS resin, an ASA resin, a polycarbonate-ABS blend, a polycarbonate-ASA blend, a polyphenylene oxide, a polycarbonate-polyphenylene oxide blend, a polycarbonate-polybutylene terephthalate blend, a polyolefin, a polypropylene, and a rubbery impact-modified polyolefin.

17. The method of claim 14, wherein said substrate layer comprises at least one filled substrate selected from the group consisting of a sheet-molding compound, a vinyl ester sheet molding compound, a bulk molding compound, a thick molding compound, a structural reaction injected molded compound, an acrylic ester-derived thermoset resin comprising a polyphenylene ether, and a long fiber injection polyurethane foam.

18. The method of claim 14, wherein said inner surface of the at least one mask layer thermoplastic film has a peel strength with respect to said outer surface of the substrate layer of greater than 1400 Newtons per meter.

19. The method of claim 14, wherein said inner surface of the at least one mask layer thermoplastic film has a peel strength with respect to said outer surface of the substrate layer of about 175 to about 1400 Newtons per meter.

20. The method of claim 14, wherein said inner surface of the at least one mask layer thermoplastic film has a peel strength with respect to said outer surface of the substrate layer of about 525 to about 1400 Newtons per meter.

21. A method of making a molded article, said method comprising: providing a multilayer thermoformable film, said film comprising (A) a top-layer thermoplastic film having an inner surface and an outer surface, said top layer thermoplastic film having a softening temperature, (B) at least one mask layer thermoplastic film, said mask layer thermoplastic film having a softening temperature within about 30 degrees centigrade of the softening temperature of the top layer film, and (C) at least one tielayer disposed between said inner surface of the top layer film and said mask layer; and heating and contacting said multilayer thermoformable film with a thermoforming tool to provide the molded article.

22. The method of claim 21, further comprising injection molding or compression molding said molded film with a substrate layer.

23. The method of claim 22, wherein said substrate layer comprises at least one of a thermoplastic polymer, a thermoset polymer, or a metal.

24. The method of claim 22, wherein said substrate layer comprises at least one thermoplastic polymer selected from the group consisting of a polycarbonate, an ABS resin, an ASA resin, a polycarbonate-ABS blend, a polycarbonate-ASA blend, a polyphenylene oxide, a polycarbonate-polyphenylene oxide blend, a polycarbonate-polybutylene terephthalate blend, a polyolefin, a polypropylene, and a rubbery impact-modified polyolefin.

25. The method of claim 22, wherein said substrate layer comprises at least one filled substrate material selected from the group consisting of a sheet-molding compound, a vinyl ester sheet molding compound, a bulk molding compound, a thick molding compound, a structural reaction injected molded compound, an acrylic ester-derived thermoset resin comprising a polyphenylene ether, and a long fiber injection polyurethane foam.

26. A molded three-dimensional article comprising a multilayer thermoformable film, said multilayer thermoformable film comprising (A) a top-layer thermoplastic film having an inner surface and an outer surface, said top layer thermoplastic film having a softening temperature, (B) at least one mask layer thermoplastic film, said mask layer thermoplastic film having a softening temperature within about 30 degrees centigrade of the softening temperature of the top layer film, and (C) at least one tielayer disposed between said inner surface of the top layer film and said mask layer.

27. The molded three-dimensional article of claim 26, wherein said molded article further comprises a substrate layer.

28. The molded three-dimensional article of claim 27, wherein said substrate layer comprises at least one of a thermoplastic polymer, a thermoset polymer, or a metal.

29. The molded three-dimensional article of claim 27, wherein said substrate layer comprises at least one thermoplastic polymer selected from the group consisting of a polycarbonate, an ABS resin, an ASA resin, a polycarbonate-ABS blend, a polycarbonate-ASA blend, a polyphenylene oxide, a polycarbonate-polyphenylene oxide blend, a polycarbonate-polybutylene terephthalate blend, a polyolefin, a polypropylene, and a rubbery impact-modified polyolefin.

30. The molded three dimensional article of claim 27, wherein said substrate layer comprises at least one filled substrate selected from the group consisting of a sheet-molding compound, a vinyl ester sheet molding compound, a bulk molding compound, a thick molding compound, a structural reaction injected molded compound, an acrylic ester-derived thermoset resin comprising a polyphenylene ether, and a long fiber injection polyurethane foam.

31. A method of making an in-mold decorated article comprising:
(a) laminating an outer surface of at least one tie layer to an inner surface of at least one top layer thermoplastic film;
(b) laminating an inner surface of said at least one tie layer to an outer surface of at least one mask layer thermoplastic film;
(c) laminating an inner surface of said at least one mask layer thermoplastic film to an outer surface of a substrate to form a multilayer thermoformable film;
(d) heating and contacting with a thermoforming tool, said multilayer thermoformable film to produce a molded film; and
(e) injection molding or compression molding a substrate layer with said molded film to produce a finished article.

32. The method of claim 31, wherein said substrate layer comprises at least one of a thermoplastic polymer, a thermoset polymer, or a metal.

33. The method of claim 31, wherein said substrate layer comprises at least one thermoplastic polymer selected from the group consisting of a polycarbonate, an ABS resin, an ASA resin, a polycarbonate-ABS blend, a polycarbonate-ASA blend, a polyphenylene oxide, a polycarbonate-polyphenylene oxide blend, a polycarbonate-polybutylene terephthalate blend, a polyolefin, a polypropylene, and a rubbery impact-modified polyolefin.

34. The method of claim 31, wherein said substrate layer comprises at least one filled substrate material selected from the group consisting of a sheet-molding compound, a vinyl ester sheet molding compound, a bulk molding compound, a thick molding compound, a structural reaction injected molded compound, an acrylic ester-derived thermoset resin comprising a polyphenylene ether, and a long fiber injection polyurethane foam.

35. The method of claim 31, wherein said at least one mask layer thermoplastic film has a 90 degree peel strength with respect to said at least one tie layer of greater than 1400 Newtons per meter, as measured using ASTM D1876 test method.

36. The method of claim 31, wherein said at least one mask layer thermoplastic film has a 90 degree peel strength with respect to said at least one tie layer of about 175 to about 1400 Newtons per meter, as measured using ASTM D1876 test method.

37. The method of claim 31, wherein said at least one mask layer thermoplastic film has a 90 degree peel strength with respect to said at least one tie layer of about 175 to about 525 Newtons per meter, as measured using ASTM D1876 test method.

38. The method of claim 31, wherein said at least one mask layer thermoplastic film has a 90 degree peel strength with respect to said substrate layer of greater than 1400 Newtons per meter, as measured using ASTM D1876 test method.

39. An article made by the method of claim 31.
